(19) United States
(12) Patent Application Publication
(10) Pub. No.: US 2006/0087625 A1
(43) Pub. Date: Apr. 27, 2006

(54) Projection apparatus

(75) Inventor: Chin-Ku Liu, Miao-Li (TW)

Correspondence Address: BACON & THOMAS, PLLC, 625 SLATERS LANE, FOURTH FLOOR, ALEXANDRIA, VA, 22314, US

(73) Assignee: Coretronic Corporation, Miao-Li (TW)

(21) Appl. No.: 11/220,588

(22) Filed: Sep. 8, 2005

(30) Foreign Application Priority Data
Oct. 22, 2004 (TW) 093132481

(51) Int. Cl. G03B 21/14

(52) U.S. Cl. 353/84

(57) ABSTRACT

A projection apparatus includes a light source for generating a light beam, and a light-filtering device disposed on the path of the light beam. The light-filtering device has a plurality of light-filtering segments. The light-filtering segments are adjacent and arranged to be a ring-shape structure, wherein at least one of the borderlines is a straight line whose extension does not pass through the center of the ring-shaped structure. The projection apparatus further includes a shifting apparatus connected to the light-filtering device in order to shift the light-filtering device.

### FIELD OF THE INVENTION

The present invention relates to a projection apparatus, and more particularly, to a projection apparatus with a light-filtering device.

### BACKGROUND OF THE INVENTION

Please refer to FIG. 1 and FIG. 2. A conventional projection apparatus 10 mainly includes a light source 11, a light-filtering device 12, an integration rod 13, a light valve 14 and a projection lens 15. The light-filtering device 12 comprises a red (R) light-filtering segment, a green (G) light-filtering segment and a blue (B) light-filtering segment, or comprises a red light-filtering segment 121, a green light-filtering segment 122, a blue light-filtering segment 123 and a white (W) light-filtering segment 124. The red light-filtering segment 121, the green light-filtering segment 122, the blue light-filtering segment 123 and the white light-filtering segment 124 are adjacent and arranged to become a ring-shaped structure. The light source 11 generates a light beam that passes through the light-filtering device 12, and the light beam sequentially becomes a red, a green and a blue light and then is uniformed by the integration rod 13 before being projected onto the light valve 14. After being processed by the light valve 14, the light beam is projected through the projection lens 15 to become images on a screen 16.

However, there are different demands for the projection apparatus in different environments. For example, high brightness is needed during a presentation while high color saturation is needed when seeing a movie. Therefore, it is a trend that a projection apparatus can provide various display modes for different environments.

Besides, there would be different visual feelings due to changes of the color temperature. Users feel warm at a low color temperature, but feel cool at a high color temperature. Therefore, it is necessary for a projection apparatus to provide the mechanism for adjusting the color temperature in order to satisfy the visual demands of each user.

The conventional projection apparatus adjusts the area proportion of light-filtering segments of each color on the light-filtering device in order to change the brightness, the color saturation and the color temperature. The increase of the brightness is achieved by increasing the area of the white light-filtering segment 123, but the areas of the red light-filtering segment 121, the green light-filtering segment 122 and the blue light-filtering segment 123 are reduced and the color saturation is consequently reduced. The change of the color saturation or the color temperature is achieved by increasing the area of the red, green or blue light-filtering segment, but the area of the white light-filtering segment 124 is reduced and the brightness of the projection apparatus is affected.

The light-filtering segments of the conventional light-filtering device are designed as a single ring-shaped structure and the borderline between each two filtering segments passes through the center of the ring-shaped structure. The color distribution of the light-filtering segments at any circle that the light beam passes through is the same. Therefore, it is impossible to provide the modes of high brightness, high color saturation, high color temperature, low color temperature and so on by changing the position of the light beam on the light-filtering device of the projection apparatus.

Please refer to FIG. 3, which is the perspective view of the light-filtering device 22 in the U.S. Pat. No. 5,650,832. A projection apparatus is disclosed that can provide various display modes. The light-filtering device 22 has two concentric ring-shaped structures 221 and 222. The concentric ring-shaped structures 221 and 222 have different area proportions of the red, green and blue light-filtering segments in order to change the color saturation. By shifting the light-filtering device 22, the location of the light beam (not shown in the figure) passing through the light-filtering device 22 is switched between the concentric ring-shaped structures 221 and 222 in order to provide different color saturations. However, the concentric ring-shaped structures of the light-filtering device increase the number of light-filtering segments and the glue between them, and then cause the complexity of the production process and the increasing of the production cost. The increasing of the glue increases the possibility of worsening of the glue which is caused by the high speed and high temperature of the light-filtering device. Moreover, when the number of the modes provided by the projection apparatus increases, for example, a higher brightness mode is added, then the number of the concentric ring-shaped structures of the light-filtering device 22 needs to be increased, which causes the complexity of the production process of the light-filtering device and the worsening of the glue.

### SUMMARY OF THE INVENTION

One objective of the present invention is to provide a projection apparatus in order to solve the above-mentioned problems encountered in the prior art.

Another objective of the present invention is to provide a projection apparatus that takes advantage of the design that the extension of the borderlines between each two light-filtering segments does not pass through the center of the ring-shaped structure, and by changing the position that the light beam projects on the light-filtering device to achieve the objective that any circle of the light-filtering device that the light beam passes through has a different color distribution of the light-filtering segments in order to provide various display modes of the projection apparatus.

For achieving the above and other objectives, the present invention provides a projection apparatus that includes a light source for generating a light beam, and a light-filtering device disposed on the path of the light beam. The light-filtering device has a plurality of light-filtering segments. The filtering segments are adjacent and are arranged to be ring-shaped, wherein the borderlines between each two light-filtering segments are straight lines whose extension does not pass through the center of the ring-shaped structure. The projection apparatus further includes a shifting apparatus which is used to change the position that the light beam passes through the light-filtering device in order to change the brightness, the color saturation and the color temperature of the projection apparatus.

### BRIEF DESCRIPTION OF THE DRAWINGS

The above and other objects, advantages, and features of the present invention will be understood from the following detailed description of the invention when considered in connection with the accompanying drawings below.

FIG. 1 is the schematic view of the conventional projection apparatus.

FIG. 2 is the front view of the conventional light-filtering device.

FIG. 3 is the front view of the light-filtering device in the U.S. Pat. No. 5,650,832.

FIG. 4 is the schematic view of the projection apparatus of the present invention.

FIG. 5 is the front view of the light-filtering device in one preferred embodiment of the present invention.

FIG. 6 is the front view of the light-filtering device in the other preferred embodiment of the present invention.

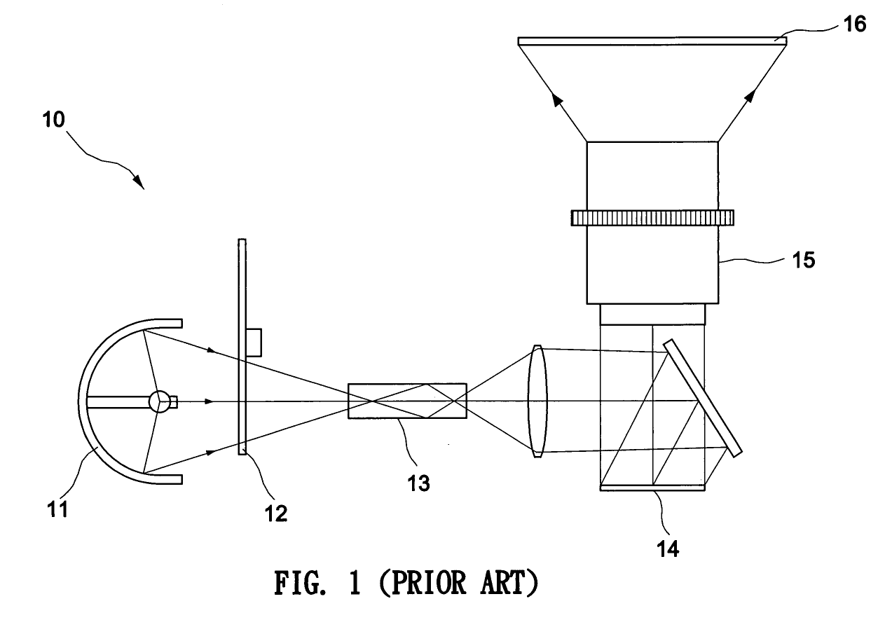

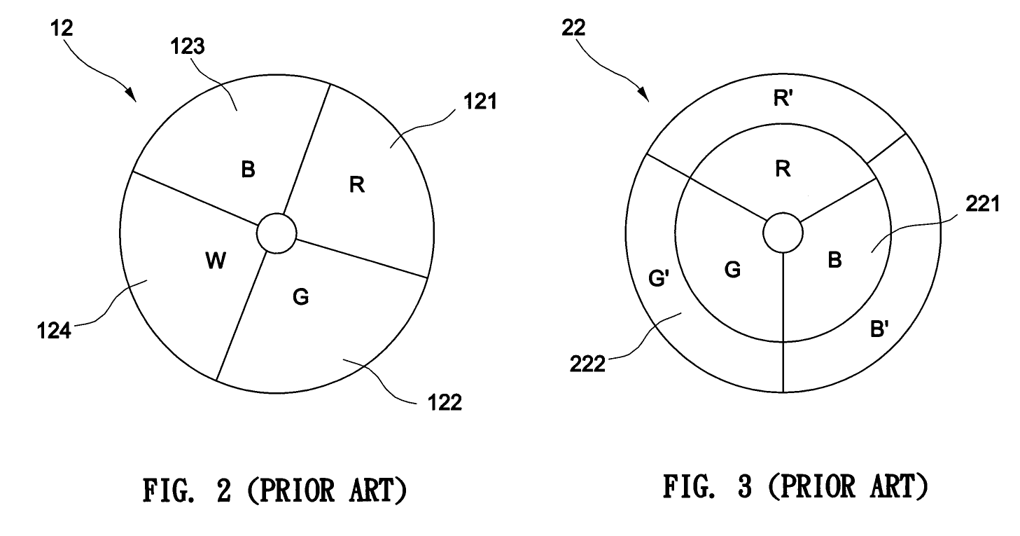

### DETAILED DESCRIPTION OF THE PREFERRED EMBODIMENT

Two preferred embodiments of the present invention will be explained with reference to the accompanying drawings.

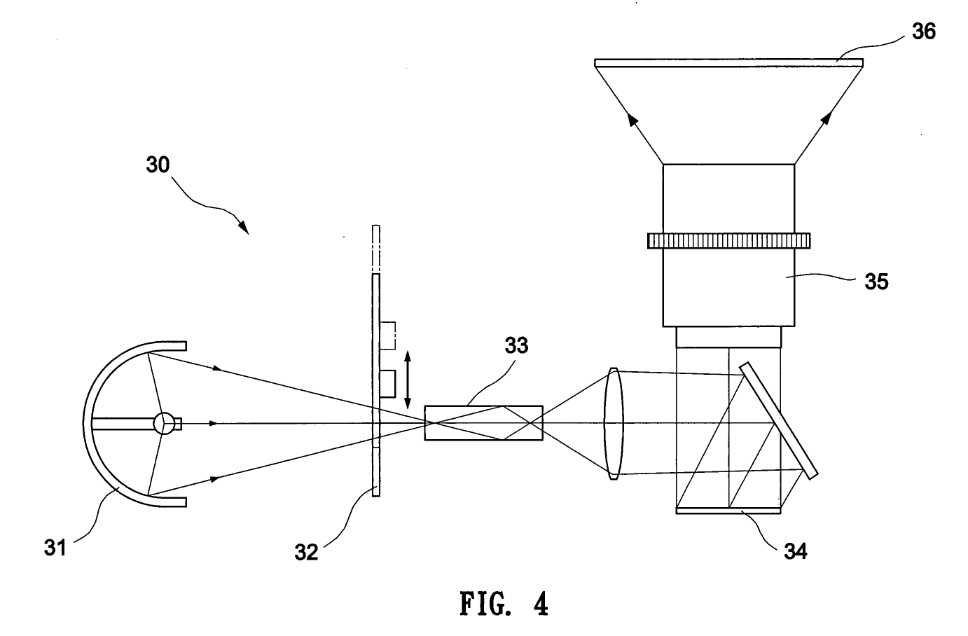

Please refer to FIG. 4, which is the schematic view of the projection apparatus 30 in the first embodiment of the present invention. The projection apparatus 30 of the present invention includes a light source 31, a light-filtering device 32, an integration rod 33, a light valve 34 and a projection lens 35. The light source 31 generates a light beam which passes through the light-filtering device 32 to become the red, green, and blue light, and then is uniformed by the integration rod 33 and projected to the light valve 34. After being processed by the light valve 34, the light is projected through the projection lens 35 and then become images on the screen 36.

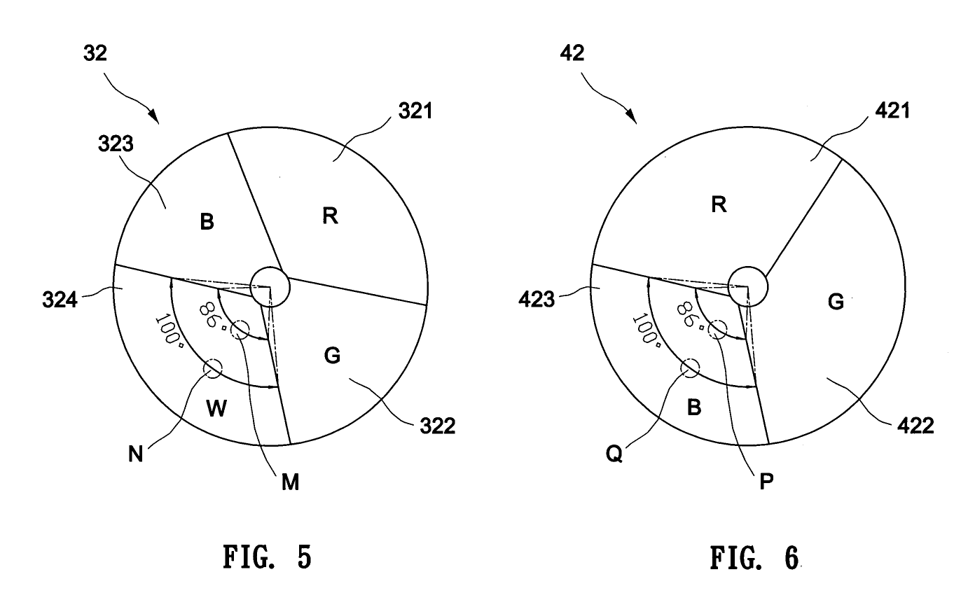

Please refer to FIG. 5, the light-filtering device 32 comprises a red light-filtering segment 321, a green light-filtering segment 322, a blue light-filtering segment 323 and a white light-filtering 324. The light-filtering segments 321, 322, 323 and 324 are adjacent and arranged to be ring-shaped. The borderlines of the red light-filtering segment 321, the green light-filtering segment 322, the blue light-filtering segment 323, and the borderlines of the white light-filtering segment 324, the green light-filtering segment 322, the blue light-filtering segment 323 are straight lines whose extension does not pass through the center of the ring-shaped structure. The projection apparatus further includes a shifting apparatus connected to the light-filtering device in order to shift the light-filtering device. The light-filtering device 32 is connected to a shifting apparatus (not shown in the figure) in order to shift the light-filtering device 32. After the shifting apparatus shifts the light-filtering device 32 to a predetermined position, the position where the light beam passes through the light-filtering device 32 is changed. As the light-filtering device 32 rotates, there are different color proportions when the light beam passes through the red light-filtering segment 321, the green light-filtering segment 322, the blue light-filtering segment 323 and the white light-filtering segment 324. When the light beam passes through the light-filtering device 32, the color saturation and the brightness will change. In this preferred embodiment, if the position of the light beam on the light-filtering device 32 changes from M to N, the light-filtering device 32 rotates around and then the proportion that the light beam pass through the white light-filtering segment 324 increases (from 86 degree to 100 degree), thus the projection apparatus 30 can be switched to a presentation mode with high brightness. On the other hand, if the position of the light beam on the light-filtering device 32 changes from N to M, the proportion that the light beam pass through the white light-filtering segment 324 decreases, thus it can be switched to the increased color saturation for movie mode.

Please refer to FIG. 6, which is the light-filtering device 42 in the second preferred embodiment of the present invention that can provide different modes of color temperature. The light-filtering device 42 comprises a red light-filtering segment 421, a green light-filtering segment 422 and a blue light-filtering segment 423. The borderlines of the blue light-filtering segment 423, the red light-filtering segment 421 and the green light-filtering segment 422 are straight lines whose extension does not pass through the center of the ring-shaped structure. The borderline of the red light-filtering segment 421 and the green light-filtering segment 422 is a straight line whose extension passes through the center of the ring-shaped structure. The light-filtering device 42 is connected to a shifting apparatus (not shown in the figure) in order to shift the light-filtering device 42. After the shifting apparatus shifting the light-filtering device 42 to a predetermined position, the position that the light beam passes through the light-filtering device 42 is changed. As the light-filtering device 42 rotates, there are different color proportion when the light beam passes through the red light-filtering segment 421, the green light-filtering segment 422 and the blue light-filtering segment 423. When the light beam passes through the light-filtering device 42, the color temperature is changed. In this preferred embodiment, if the position of the light beam on the light-filtering device 42 changes from P to Q, the light-filtering device 42 rotates and then the proportion that the light beam pass through the blue light-filtering segment 423 increases (from 86 degree to 100 degree), thus the projection apparatus can be switched to a high color temperature (that is, cooler feeling) mode. On the other hand, if the position of the light beam on the light-filtering device 42 changes from Q to P, the proportion that the light beam passes through the blue light-filtering segment 423 decreases, thus the projection apparatus can be switched to a low color temperature (that is, warmer feeling) mode.

The red light-filtering segment, the green light-filtering segment, the blue light-filtering segment and the white light-filtering segment of the above-mentioned preferred embodiments can be composed of a red filter, a green filter, a blue filter and a white filter or can be achieved by coating a red light-filtering coating, a green light-filtering coating and a blue light-filtering coating on a transparent plate.

In addition, at least one of the borderlines is a straight line whose extension does not pass through the center of the ring-shaped structure. The other borderlines can be straight lines whose extension passes through the center of the ring-shaped structure, or straight lines whose extension does not pass through the center of the ring-shaped structure. This is determined by the demands of the brightness, saturation, or the color temperature of the projection apparatus. Moreover, by adjusting the slope of the straight lines or designing the borderlines between the light-filtering segments to turning lines that has various slopes can make the projection apparatus have various modes.

Compare to the conventional projection apparatus, the light-filtering device in the projection apparatus of the present invention, wherein the light-filtering segments of the light-filtering device are designed as a single ring-shaped structure to provide various modes of the projection apparatus. Therefore the objective of simplifying the production process of the light-filtering device and the efficiency of lowering the cost are achieved, by providing various modes for displaying in order to satisfy the demands of different users or the visual demands in different environments.

Although the invention has been described in detail herein with reference to its preferred embodiments, it is to be understood that this description is by way of example only, and is not to be interpreted in a limiting sense. It is to be further understood that numerous changes in the details of the embodiments of the invention, and additional embodiments of the invention, will be apparent, and may be made by, persons of ordinary skill in the art having reference to this description. It is considered that such changes and additional embodiments are within the spirit and true scope of the invention as claimed below.

1. A projection apparatus, comprising:
a light source for generating a light beam;
a light-filtering device disposed on the path of the light beam and having a plurality of light-filtering segments, the light-filtering segments being adjacent and arranged to be ring-shaped, wherein at least one of the borderlines of two adjacent light-filtering segments is a straight line whose extension does not pass through the center of the ring-shaped light-filtering segments, and
a shifting apparatus connected to the light-filtering device for shifting the light-filtering device.

2. The projection apparatus according to claim 1, wherein the plurality of light-filtering segments comprises a red light-filtering segment, a green light-filtering segment and a blue light-filtering segment.

3. The projection apparatus according to claim 2, wherein the plurality of light-filtering segments comprises a white light-filtering segment.

4. The projection apparatus according to claim 1, wherein the shifting apparatus is used for changing the position of the light beam passing through the light-filtering device to change the brightness, color saturation and color temperature of the projection apparatus.

5. The projection apparatus according to claim 1, wherein the plurality of light-filtering segments comprises a plurality of filters.

6. The projection apparatus according to claim 1, wherein the plurality of light-filtering segments is made by coating on a transparent plate.
